(19) United States
(12) Patent Application Publication
(10) Pub. No.: US 2025/0033962 A1
(43) Pub. Date: Jan. 30, 2025

(54) SYSTEM AND METHOD FOR PRODUCING HYDROGEN USING AUTOTHERMAL REFORMING

(71) Applicants: Infinity Environment Corp., Changwon-si (KR); HYEONJIN E&P Co., Ltd., Gimhae-si (KR)

(72) Inventor: YOUNGSIK YOON, Yongin-si (KR)

(21) Appl. No.: 18/769,524

(22) Filed: Jul. 11, 2024

(30) Foreign Application Priority Data
Jul. 26, 2023 (KR) 10-2023-0097180

(51) Int. Cl. C01B 3/48

(52) U.S. Cl. CPC C01B 3/48; C01B 2203/0233; C01B 2203/025; C01B 2203/0283; C01B 2203/042; C01B 2203/047; C01B 2203/0485; C01B 2203/0805; C01B 2203/1235

(57) ABSTRACT

The present disclosure relates to a system and method for producing hydrogen from hydrocarbons using autothermal reforming. In particular, as a system for producing hydrogen from hydrocarbons, a system for producing hydrogen using autothermal reforming includes: a partial oxidation portion where hydrocarbons are fed in and undergoes partial oxidation, a stem reforming portion that is connected to the partial oxidation portion, supplied with heat energy generated from the partial oxidation portion, and steam-reformed by a steam reforming catalyst to produce synthetic gas containing hydrogen, and an integrated autothermal reforming reactor wherein the partial oxidation portion and the steam reforming portion are configured within a single integrated main body.

### CROSS-REFERENCE TO RELATED APPLICATIONS

This application claims priority to and the benefit of Korea Patent Application No. 10-2023-0097180 filed in the Korean Intellectual Property Office on Jul. 26, 2024, the contents of which are incorporated herein by reference in their entirety.

### BACKGROUND

### Technical Field

The present disclosure relates to a system and method for producing hydrogen using autothermal reforming (ART). More particularly, this relates to a system and method for producing hydrogen from low-quality hydrocarbons using an autothermal reforming reactor incorporating partial oxidation and a steam reformer, along with a process for hydrodesulfurization, dechlorization and denaphthaization.

### Related Art

Currently, the need to develop hydrogen production processes using hydrocarbons is becoming increasingly apparent. The demand for hydrogen as a clean energy source is growing, but there is a limit to the amount of hydrogen that can be produced by industry.

The demand for hydrogen production using low-quality hydrocarbons that can be utilized from thermal pyrolysis oil produced in the pyrolysis process of waste plastics is increasing. In other words, high-quality hydrocarbons are mostly traded at high prices in industrial processes, making the application of hydrogen production processes using finished hydrocarbons uneconomical.

In the conventional industrial setting for hydrogen production, most of the hydrogen produced domestically and internationally is byproduct hydrogen. By-product hydrogen is produced in the petrochemical industry as a byproduct of refining crude oil for petrochemical production. Hydrogen that is used and remains in the hydroprocessing under high-temperature and high-pressure conditions for desulfurization/dechlorization/denaphthaization in the processes of the petrochemical industry is being sold externally.

Recently, the demand for clean energy sources such as hydrogen vehicles and fuel cell power generation has increased, there is a shortages in the supply of hydrogen.

Representative examples of hydrocarbons that are already produced and sold as products are petrochemical products including LPG, diesel, kerosene, gasoline, heavy fuel oil and natural gas (NG).

Natural gas prices are skyrocketing due to recent supply shortages and hydrogen production processes using natural gas are not reasonable due to significant fluctuations in raw material prices and a multitude of demanders.

One of major challenges hindering the commercialization of hydrogen production process using low-grade hydrocarbons is initial capital investment and operating costs associated with purifying raw materials including sulfur(S), chlorine (Cl) and heavy metals.

There are significant financial risks associated with commercializing the technology and there is also a burden to resolve the current issue of hydrogen supply shortages.

In particular, waste plastic pyrolysis oil has the drawback of being lower quality compared to conventional petroleum products. The process for hydrodesulfurization, dechlorization and denaphthaization is essential for hydrogen production processes using low-quality hydrocarbons. The removal of lead and impurities can be carried out relatively easily. However, sulfur and chlorine compounds bound to organic matters are difficult to remove using conventional adsorption/separation processes.

### RELATED ART DOCUMENT

### Patent Document

(Patent Document 1) U.S. Pat. No. 10,513,661
(Patent Document 2) Korean Laid-open Patent No. KR2022-0145153
(Patent Document 3) Korean Laid-open Patent No. KR2023-0037832

### DETAILED DESCRIPTION

### Technical Problem

Therefore, the present disclosure is contrived to address conventional issues as described above. According to an embodiment of the present disclosure, it relates to a method for obtaining 99.999% hydrogen using hydrocarbons, and aims to provide a method for producing high-purity hydrogen using thermal pyrolysis oil produced from the pyrolysis process of waste plastics or light oil in a narrow range, and using hydrocarbons in both gas and liquid phases in a broad range.

The hydrogen production process using hydrocarbons employs steam reforming reaction. The steam reforming reaction is an endothermic reaction that requires a continuous supply of heat energy. High carbon number hydrocarbons have a low hydrogen production yield in steam reforming catalytic processes, and also have the drawback of reducing the activity of catalysts due to unreacted carbon deposit (coking) on the catalysts. According to an embodiment of the present disclosure, it aims to provide a hydrogen production process using autothermal reforming reaction, which decomposes hydrocarbons primarily and secures heat energy required for the steam reforming reactor by configuring a partial oxidation reactor at the front end of the steam reforming catalytic process.

In addition, to obtain ultra-high purity hydrogen of 5N (99.999%) or higher, the operation of PSA process is essential. In the PSA process, Tail Gas discharged in the later part of the operating cycle has low hydrogen density. Therefore, according to an embodiment of the present disclosure, it aims to provide a hydrocatalytic process for desulfurization/dechlorization/denaphthaization, which secures operation efficiency by utilizing this Tail Gas in the hydrodesulfurization/hydrodechlorization/denaphthaization process and allows for reuse of once-used gas through recycling.

Further, according to an embodiment of the present disclosure, it aims to provide a method for utilizing Tail Gas of PSA for separating high-purity hydrogen, which finally utilizes a heat source using a separate burner system when the utility of the recycled Tail Gas is exhausted.

Meanwhile, technical objects to be achieved in the present invention are not limited to the aforementioned technical objects, and other technical objects, which are not mentioned above, will be apparently understood to a person having ordinary skill in the art from the following description.

### Technical Solution

A first aspect of the present disclosure relates to a system for producing hydrogen from hydrocarbons and it can be achieved by a system for producing hydrogen using autothermal reforming including a partial oxidation portion where hydrocarbons are fed in and undergoes partial oxidation, a stem reforming portion that is connected to the partial oxidation portion, supplied with heat energy generated from the partial oxidation portion, and steam-reformed by a steam reforming catalyst to produce synthetic gas containing hydrogen, and an integrated autothermal reforming reactor wherein the partial oxidation portion and the steam reforming portion are configured within a single integrated main body.

In addition, the partial oxidation portion is operated within a range of 1000˜1500° C. through a burner, and supplied with pure-oxygen as an oxidizer, and a supply line through which hydrocarbons are supplied is spirally installed inside or outside a housing of the partial oxidation portion, and gasifies hydrocarbons through heat energy generated from the partial oxidation portion to supply inside the partial oxidation portion.

Further, the system further includes a PSA hydrogen separator that separates hydrogen from the synthetic gas; and a hydrocatalytic reactor that is provided at the front end of the autothermal reforming reactor, and subjects the hydrocarbons to defulrization, dechlorization and denaphthaization. Tail gas of the PSA is supplied to the hydrocatalytic reactor.

In addition, the system further include a desulfurization/dechlorization adsorber that is provided at the rear end of the autothermal reforming reactor, and adsorbs sulfur and chlorine inside the synthetic gas, and a water-gas shift reactor that is provided between the PSA and the autothermal reforming reactor, and converts CO in the synthetic gas into carbon dioxide and hydrogen.

Further, in the hydrocatalytic reactor, H₂S, HCl, HNH₃ are produced through hydrogenation, unsaturated hydrocarbons are converted into saturated hydrocarbons, and denaphthaization is also carried out.

In addition, the water-gas shift reactor includes a high-temperature water-gas shift reactor that converts 60˜80% of CO into CO₂ and H₂ by injecting steam at a temperature range of 250˜300° C., and a low-temperature water-gas shift reactor that is connected to the rear end of the high-temperature water-gas shift reactor, and converts residual CO into CO₂ and H₂ by injecting steam at a temperature range of 200˜250° C.

Further, the system includes a hydrogen storage tank for storing the hydrogen separated from the PSA; and a tail gas storage tank for storing the tail gas of the PSA. The tail gas stored in the tail gas storage tank is supplied to the hydrocatalytic reactor and a gas burner of the partial oxidation reactor.

In addition, the gas containing the hydrocarbons, CO and hydrogen discharged from the hydrocatalytic reactor is supplied to the gas burner.

Further, the system further includes a pre-treating portion that is provided at the front end of the hydrocatalytic reactor, and undergoes pre-treatment through a porous support containing silica gel, clay, alkali metal oxide or alkaline earth metal oxide, iron oxide, ion exchange resin, activated carbon, activated aluminum oxide, molecular sieve, alkaline oxide, modified or unmodified layered double hydroxide, and silica gel.

### Advantageous Effects

According to an embodiment of the present disclosure, it relates to a method for obtaining 99.999% hydrogen using hydrocarbons, which is capable of producing high-purity hydrogen using thermal pyrolysis oil produced from the pyrolysis process of waste plastics or light oil in a narrow range, and using hydrocarbons in both gas and liquid phases in a broad range.

The hydrogen production process using hydrocarbons employs steam reforming reaction. The steam reforming reaction is an endothermic reaction that requires a continuous supply of heat energy. High carbon number hydrocarbons have a low hydrogen production yield in steam reforming catalytic processes, and also have the drawback of reducing the activity of catalysts due to unreacted carbon deposit (coking) on the catalysts. According to a hydrogen production process using autothermal reforming reaction in accordance of the embodiment of the present disclosure, it is capable of decomposing hydrocarbons primarily and securing heat energy required for the steam reforming reactor by configuring a partial oxidation reactor at the front end of the steam reforming catalytic process.

In addition, to obtain ultra-high purity hydrogen of 5N (99.999%) or higher, the operation of PSA process is essential. In the PSA process, Tail Gas discharged in the later part of the operating cycle has low hydrogen density. Therefore, according to a hydrocatalytic process for desulfurization/dechlorization/denaphthaization in accordance of the embodiment of the present disclosure, it is capable of securing operation efficiency by utilizing this Tail Gas in the hydrodesulfurization/hydrodechlorization/denaphthaization process and appearing advantages of allowing for reuse of once-used gas through recycling.

Further, according to a method for utilizing Tail Gas of PSA for separating high-purity hydrogen in accordance of the embodiment of the present disclosure, it is capable of increasing energy efficiency by finally utilizing a heat source using a separate burner system when the utility of the recycled Tail Gas is exhausted.

Meanwhile, advantageous effects to be obtained in the present disclosure are not limited to the aforementioned effects, and other effects, which are not mentioned above, will be apparently understood to a person having ordinary skill in the art from the following description.

### BRIEF DESCRIPTION OF THE DRAWINGS

The accompanying drawings of this specification exemplify a preferred embodiment of the present disclosure, the spirit of the present disclosure will be more clearly understood from the following detailed description taken in conjunction with the accompanying drawings, and thus it will be understood that the present disclosure is not limited to only contents illustrated in the accompanying drawings;

FIG. 1 is a block view of a system for producing hydrogen using autothermal reforming according to an embodiment of the present disclosure,

FIG. 2 is a flowchart of a method for producing hydrogen using autothermal reforming according to an embodiment of the present disclosure,

FIG. 3 is a schematic view of a detailed autothermal reforming reactor and its connection configuration according to an embodiment of the present disclosure,

FIG. 4 is a process view of energy supply for hydro-desulfurization/-dechlorization and denaphthaization using tail gas according to an embodiment of the present disclosure,

FIG. 5A is a cross-sectional view of a gun-type tail gas burner according to an embodiment of the present disclosure, and

FIG. 5B is a perspective view of a gun-type tail gas burner according to an embodiment of the present disclosure.

### DETAILED DESCRIPTION

Hereinafter, the aforementioned aims, other aims, features and advantageous effects of the present disclosure will be understood easily referring to preferable embodiments related to the accompanying drawings. However, the present disclosure is not limited to embodiments described in this specification, and may be embodied into other forms. Preferably, the embodiments in this specification are provided in order to allow disclosed contents to be exhaustive and to communicate the concept of the present disclosure to those skilled in the art.

In this specification, when a certain element is placed on another element, this means that it may be formed directly thereon or that the third element may be interposed between them. Further, in the drawings, the thickness of an element may be overstated in order to explain the technical content thereof efficiently.

The embodiments described in this specification will explained with reference to a cross-sectional view and/or a plane view. In the drawings, the thickness of a film and a region may be overstated in order to explain the technical content thereof efficiently. Accordingly, the form of exemplary drawings for a fabrication method and/or an allowable error et cetera may be reformed. Thus, the embodiments according to the present disclosure are not limited to specific forms illustrated herein, but may include variations in the form resulting from the fabrication method. For example, the region illustrated with perpendicular lines may have a form to be rounded or with a predetermined curvature. Thus, regions exemplified in the drawings have attributes, and shapes thereof exemplify specific forms rather than limiting the scope of the present disclosure. In the various embodiments of this specification, terms such as ‘first’ and ‘second’ et cetera are used to describe various elements, but these elements should not be limited to such terms. These terms are merely used to distinguish one element from others. The embodiments explained and exemplified herein may include complementary embodiments thereto.

The terms used in this specification is to explain the embodiments rather than limiting the present disclosure. In this specification, the singular expression includes the plural expression unless specifically stated otherwise. The terms, such as ‘comprise” and/or “comprising” do not preclude the potential existences of one or more elements.

When describing the following specific embodiments, various kinds of specific contents are made up to explain the present disclosure in detail and to help understanding thereof. However, it will be apparent for those who have knowledge to the extent of understanding the present disclosure that the present disclosure can be used without any of these specific contents. In a certain case when describing the present disclosure, the content that is commonly known to the public but is largely irrelevant to the present disclosure is not described in order to avoid confusion.

Hereinafter, described are the configuration, functions, and production method of a system for producing hydrogen using autothermal reforming according to an embodiment of the present disclosure.

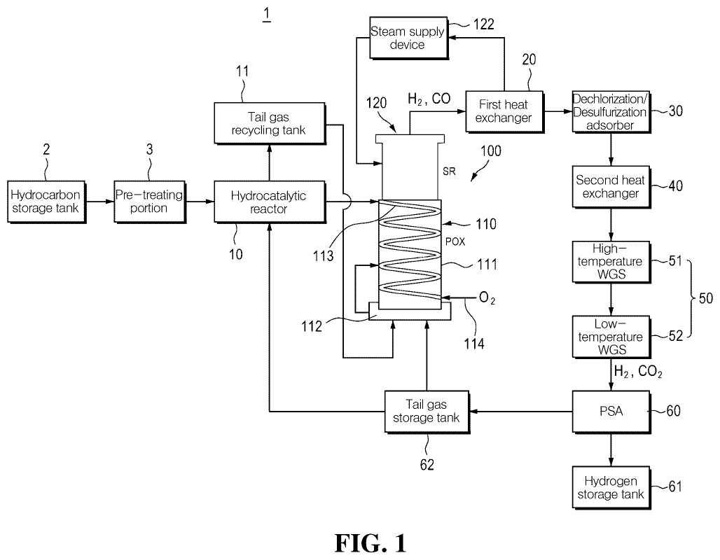

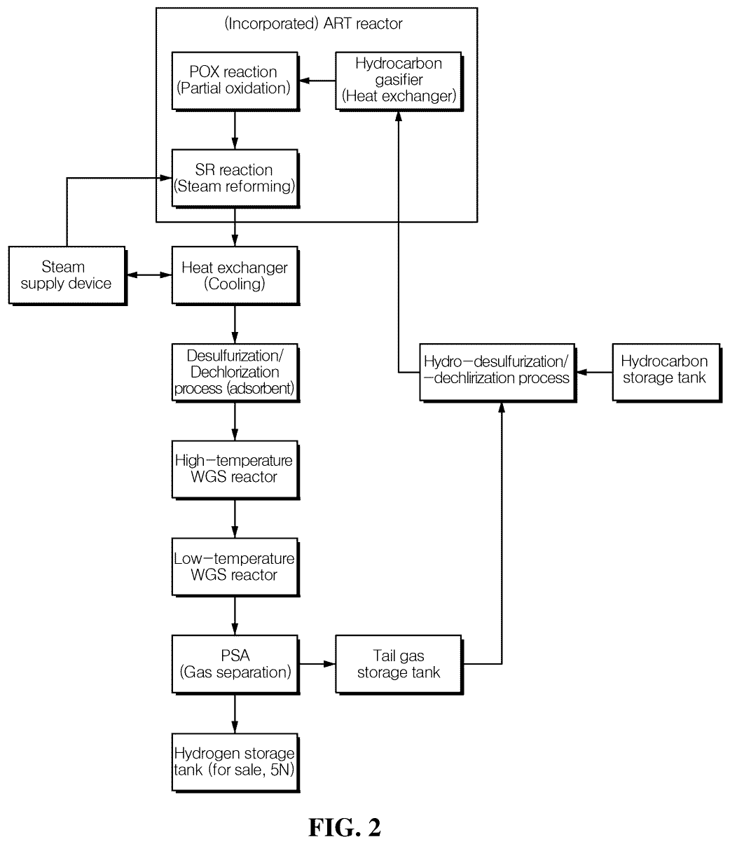

FIG. 1 is a block view of a system for producing hydrogen using autothermal reforming according to an embodiment of the present disclosure. FIG. 2 is a flowchart of a method for producing hydrogen using autothermal reforming according to an embodiment of the present disclosure.

As shown in FIG. 1 and FIG. 2, it can be seen that a system for producing hydrogen using autothermal reforming 1 according to an embodiment of the present disclosure is, its entirety, configured to include a hydrocarbon storage tank 2, a hydrocatalytic reactor 10, an incorporated autothermal reforming reactor (ART) 100, a first heat exchanger 20, adsorber 30, a second heat exchanger 40, a water-gas shift (WGS) reactor 50, a (PSA) hydrogen separator 60, and a tail gas storage tank 60.

The hydrocarbon storage tank 2 stores low-quality hydrocarbons. In particular, the low-quality hydrocarbon may be low-quality waste plastic pyrolysis oil that is produced through waste plastic pyrolysis reaction.

The hydrocatalytic reactor 10 is provided at the front end of the autothermal reforming reactor 100, and is configured to be supplied with hydrogen and to subject hydrocarbons to desulfurization, dechlorization and denaphthaization in the presence of hydrocatalysts.

The incorporated autothermal reactor (ART) 100 is configured to produce synthetic gas containing hydrogen and CO through a single reactor incorporating a partial oxidation reactor 110 and a steam reformer 120.

Further, the adsorber 30 is provided at the rear end of the autothermal reforming reactor 100 and configured to adsorb sulfur and chlorine through an adsorbent.

The water-gas shift reactor 50 is configured to undergo water-gas shift reaction by water-gas shift catalysis and to convert CO into hydrogen and carbon dioxide.

The (PSA) hydrogen separator 60 separates and captures hydrogen discharged from the WGS 50 and stores it in the hydrogen storage tank. Tail gas is stored in the tail gas storage tank.

This tail gas is supplied to the hydrocatalytic reactor 10 as hydrogen for the reaction. As will be described later, this serves as fuel of a gas burner provided in the partial oxidation portion 110 of the incorporated autothermal reforming reactor 100.

The partial oxidation portion 110 of the incorporated autothermal reforming reactor 100 is operated within a range of 1000˜1500° C. through a gas burner 112, and supplied with pure-oxygen as an oxidizer.

Further, a supply line 113 through which hydrocarbons are supplied is configured to be spirally installed inside or outside a housing of the partial oxidation portion 110, and to gasify hydrocarbons through heat energy generated from the partial oxidation portion 110 to supply inside the partial oxidation portion 110.

In addition, as will be described in more detail later, the hydrocatalytic reactor 10 is configured to produce H₂S, HCl, HNH₃ through hydrogenation and to convert unsaturated hydrocarbons into saturated hydrocarbons.

Further, the water-gas shift reactor 50 may be configured to include a high-temperature water-gas shift reactor 51 that converts 60˜80% of CO into CO₂ and H₂ by injecting steam at a temperature range of 250˜300° C., and a low-temperature water-gas shift reactor 52 that is connected to the rear end of the high-temperature water-gas shift reactor 51, and converts residual CO into CO₂ and H₂ by injecting steam at a temperature range of 200˜250° C.

Further, a hydrogen storage tank 61 may be included to store the hydrogen separated from the PSA and a tail gas storage tank 21 may be included to store the tail gas of the PSA. The tail gas stored in the tail gas storage tank 62 may be supplied to the hydrocatalytic reactor and the gas burner 112 of the partial oxidation reactor.

Further, the gas containing the hydrocarbons, CO and hydrogen discharged from the hydrocatalytic reactor 10 may be supplied to the gas burner as fuel after undergoing a rinsing process.

In addition, a pre-treating portion 3 may be provided at the front end of the hydrocatalytic reactor 10.

In this pre-treating portion 3, pre-treatment may be carried out through a porous support containing silica gel, clay, alkali metal oxide or alkaline earth metal oxide, iron oxide, ion exchange resin, activated carbon, activated aluminum oxide, molecular sieve, alkaline oxide, modified or unmodified layered double hydroxide, and silica gel.

The activated carbon refers to a porous carbon material providing a highly developed porous structure and a large specific area and is preferably provided in granular or pellet form. The activated carbon may have a specific area (BET) of preferably 100 to 100 m²/g, more preferably 300 to 700 m²/g, even more preferably 500 to 600 m²/g, even more preferably 545 to 555 m²/g, and even more preferably 550 m²/g.

The pre-treatment captures silicon and/or metal and/or phosphorus and/or halode, thereby increasing the efficiency of the hydrogenation reaction.

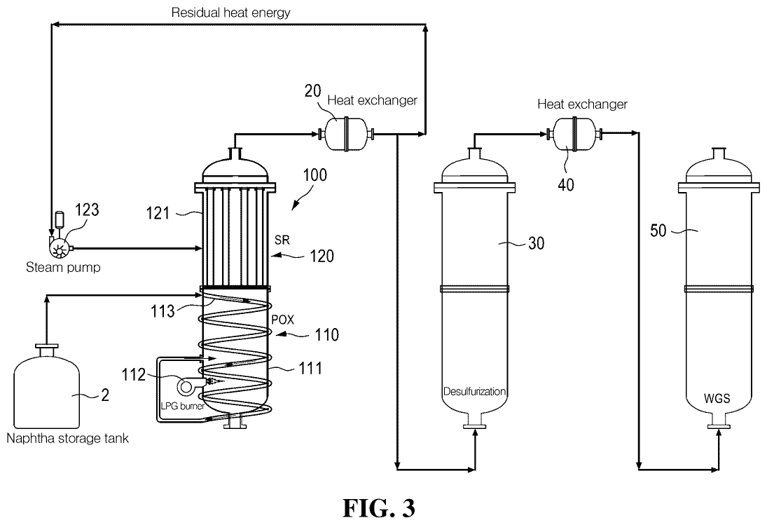

FIG. 3 is a schematic view of a detailed autothermal reforming reactor and its connection configuration according to an embodiment of the present disclosure.

The partial oxidation reaction is a reaction in which less oxygen is supplied than is required for complete combustion. The partial oxidation reaction of hydrocarbons can be simplified as follows.

$${C}_{n} {H}_{m} + ( n / 2 ) {O}_{2} = n CO + ( m / 2 ) {H}_{2}$$

In the POX reaction, a large amount of oxygen is required to completely carry out the reaction towards right-hand side of the above chemical equation, and some CO₂ and unreacted hydrocarbons may be discharged.

Further, the POX reaction is an exothermic reaction, which means that the chemical energy possessed by raw materials is diffused into heat energy. Therefore, this has the drawback that the amount of energy loss is high thermodynamically.

The steam reforming (SR) reaction of a steam reforming portion is a reaction in which hydrocarbons and steam are supplied to a reactor with catalysts to produce hydrogen, and can be simplified as follows.

$${C}_{n} {H}_{m} + {n H}_{2} O = n CO + ( m / 2 + n ) {H}_{2}$$

The SR reaction is an endothermic reaction, which requires an external supply of heat energy to carry out the reaction towards the right-hand side of the above chemical equation.

A steam reforming catalyst may be composed of a physical mixture of the following substances a) and b).

The steam reforming catalyst includes a mixed oxide of nickel, aluminum, and zirconium as a substance a), and an additional oxygen-containing compound selected from the group consisting of aluminum hydroxide [Al(OH)₃], aluminum oxyhydroxide [AlO(OH)], and aluminum oxide (Al₂O₃) as a substance b).

In addition, this may include gamma (γ)-aluminum oxide (γ-Al₂O₃), delta (δ)-aluminum oxide (δ-Al₂O₃), or theta (θ)-aluminum oxide (θ-Al₂O₃), or a mixture thereof as a substance b).

Further, the steam reforming catalyst may be a steam reforming catalyst where Ni serves as the active metal on an aluminum support. Specifically, this may be a microparticle eggshell steam reforming catalyst containing 2.5 to 9.5 wt. % of nickel represented as NiO. The nickel is provided as a layer on the surface of the catalyst and the thickness of the layer is within the range of 100 to 1000 μm, preferably 100 to 600 μm. Nickel is supported on a shaped microparticle catalyst support containing alumina, titania or zirconia, or an alkaline earth metal aluminate, preferably one or more calcium aluminate compounds and/or magnesium aluminate.

When conducting POX reaction and SR reaction concurrently, there is one advantage that the heat energy generated from the POX reaction can be conserved and utilized for the SR reaction.

Further, a liquid hydrocarbon supply line 113 is spirally installed on the wall of the partial oxidation portion 110, allowing for recovery of additional waste heat.

When oxygen is used as an oxidizer in the POX reaction, it exhibits the following characteristics. 1) When supplying air as an oxidizer, the high N2 content leads to an increase in the design volume of the post-processing process in the autothermal reforming reactor, such as WGS process, PSA process and the like. 2) When using oxygen as an oxidizer, the high-purity oxygen leas to an increase in operating costs, while allowing for save of the initial capital investment and operating costs of the post-treating process.

Further, the temperature inside the partial oxidation portion 110 using oxygen may extremely increase to approximately 1,200˜1,400° C.

The supply line 113 that supplies raw materials is placed on the outer wall of the partial oxidation portion 110 to cool the partial oxidation portion 110 with the supplied raw materials and at the same time, the supplied raw materials may be gasified to control the temperature to below 1,000° C. Therefore, the energy for gasifying raw materials may be reduced by the incorporated reaction process according to an embodiment of the present disclosure.

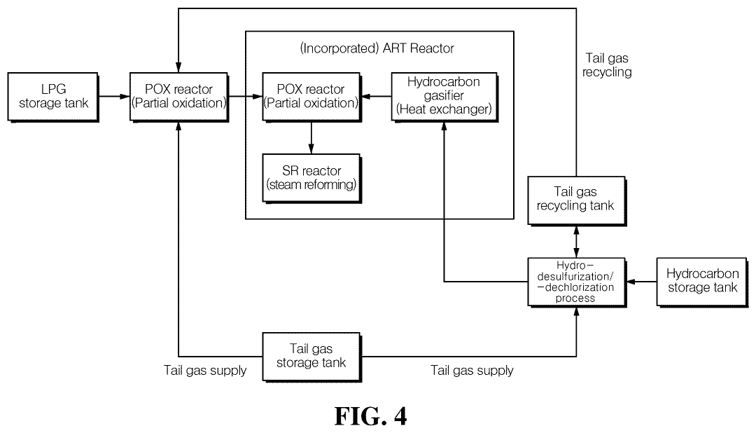

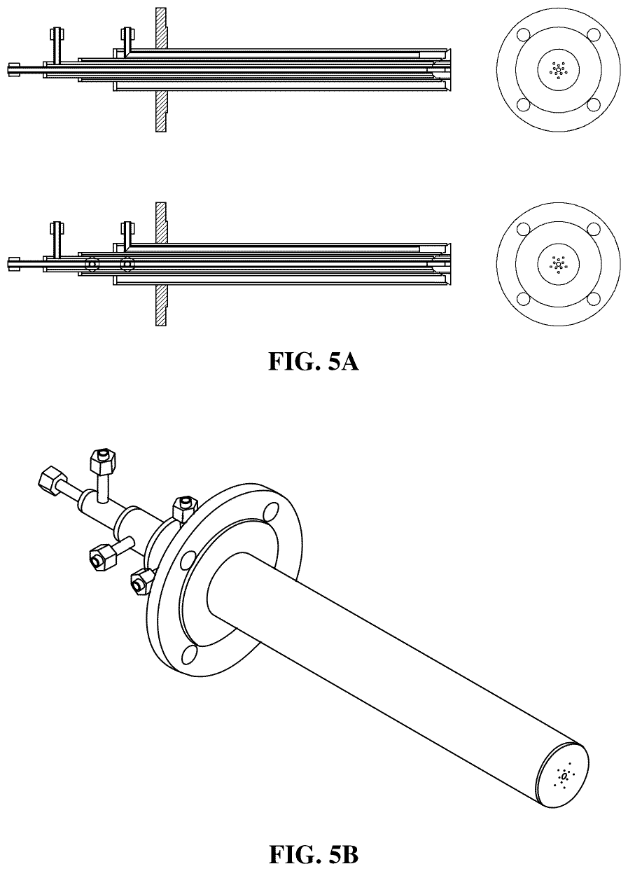

FIG. 4 is a process view of energy supply for hydro-desulfurization/-dechlorization and denaphthaization using tail gas according to an embodiment of the present disclosure.

The hydrocatalytic reactor 10 according to an embodiment of the present disclosure may perform a desulfurization/dechlorization process and a denaphthalization process for hydrocarbons. Hydrogen for the hydrogenation reaction employs tail gas of PSA.

S and Cl may be converted into H₂S and HCl and then removed through the hydrogenation reaction (hydrodesulfurizatiion, hydrodechlorization) as shown in the following reaction equation.

The PSA 60 process is typically operated at a pressure of 0.3 Mpa˜6 Mpa, with the desorption process operating at −0.1 Mpa.

Since the PSA 60 process operates at high pressure, the gas may also be discharged from the PSA 60 at a pressure of 0.3˜5 Mpa, and the gas may be supplied to the hydro-desulfurization/-dechlorization process that requires high temperature and pressure, without any separate gasification process.

$$\begin{matrix}R - S - {R}^{′} + 2 {H}_{2} = R - H + {R}^{′} - H + {H}_{2} S \\ {C}_{2} {H}_{4} {S}_{2} + 2 {H}_{2} = {C}_{2} {H}_{6} + {H}_{2} S \\ {C}_{6} {H}_{5} Cl + {H}_{2} = {C}_{6} {H}_{6} + HCl\end{matrix}$$

Further, in the hydrocatalytic reactor 10 according to an embodiment of the present disclosure, hydrodesulfurization process is carried out. In other words, unsaturated hycrocarbons are saturated. Aliphatic saturated hydrocarbons are called paraffins and have the chemical formula of CₙH₂ₙ₊₂.

The aliphatic unsaturated hydrocarbons are called olefins and have the chemical formula of CₙH₂ₙ.

Olefins are highly reactive with other materials due to a carbon-carbon double bond and thus are used for the synthesis of various materials in the petrochemical industry.

However, in the context of fuel, unsaturated hydrocarbons are limited in content because of their high reactivity which makes them susceptible to oxidation and deterioration.

When hydrogen is added to raw materials in which a part unsaturated hydrocarbons exist, hydrogen is added to the double bond position between carbons to convert olefins to paraffins. During this process, hydrocracking of relatively large-molecular-weight chain hydrocarbons may occur leading to denapthalization effects.

The denaphthalization reaction decomposes hydrocarbons with large molecule structures into smaller units, helping prevent coking on the catalyst surface inside an autothermal reforming reactor, maintain catalyst life span and improve reaction efficiency.

### <Saturation Reaction of Unsaturated Hydrocarbons>

$${C}_{n} {H}_{2 n} + {H}_{2} = {C}_{n} {H}_{2 n + 2}$$

### <Denaphthalization (Dewaxing) Reaction>

$${H}_{2} {CR}^{′} - {R}^{″} {CH}_{2} + {H}_{2} = {R}^{′} {CH}_{3} + {R}^{″} {CH}_{3} ( Catalytic Reaction )$$

Catalysts applied to the hydrocatalytic reactor 10 may include, as an active metal, at least one metal of group VIII and/or group VIII B, such as Ni and/or Co, and/or at least one metal of group VI B which is either used alone or combines with a promoter selected from mixtures of the aforementioned metals of group VIII and/or group VIII B, such as Mo and W.

Alternatively, the catalyst may be configured to include (i) at least one hydrogenation active metal component selected from the group consisting of metals of group VI B and group VIII and (ii) alumina, silica, silica-alumina, titanium oxide, molecular sieve, zirconia, aluminum phosphate, carbon, niobium, or a mixture thereof, that is, a carrier (support).

In addition, the catalyst may be a catalyst in which an active metal including any one or at least two selected from molybdenum, nickel, cobalt, and tungsten is supported on an alumina support. For example, a hydrocatalyst may be palladium-alumina based catalysts, NiMo/r-Al₂O₃ catalysts, CoMo/r-Al₂O₃ catalysts, or NiMo sulfide based catalysts.

Additionally, when hydrogen concentration of Tail Gas used in the hydro-desulfurization/-dechlorization and dehaphatalization processes is reduced to below 3%, it may be utilized as fuel gas.

Specially, the recycled tail gas may contain sulfur, chlorine and nitrogen components removed from the low-quality hydrocarbons in the form of H₂S, HCl and HNH₃, respectively. These components ma cause environmental pollution when discharged into the atmosphere.

In addition to the discharged materials, the recycled tail gas contains hydrocarbons, CO, low-concentrations of H₂, and thus it may be supplied to a burner after undergoing a separate rinsing process.

In a water-gas shift reactor (WGS) according to an embodiment of the present disclosure, steam is supplied in the presence of water-gas shift catalysts to carry out the water-gas shift reaction, thereby converting CO into H₂ and CO₂.

The water-gas shift catalysis may employ a metal-organic framework-supported Cu/CeO₂ catalysts. Specifically, catalysts in which Cu, as an active metal, is supported on a CeO₂ support may be employed. This catalysis for the water-gas shift reaction involves steps of manufacturing metal-organic framework (hereinafter referred to as MOF)-based Cu/CeO₂ catalysts and of supporting Cu on this support.

Firstly, trimesic acid and cerium nitrate hydrate are hydrothermally synthesized. In particular, 2.1 g of 10 mmol Trimesic acid (H3-BTC) and 4.43 g of 10 mmol Cerium (III) nitrate hexahydrate are dissolved in 60 mL of (DMF) (S11). The resulting solutes are maintained at 103˜150° C. for 24 hours in a hydrothermal reactor, dried and then sintered to manufacture CeO₂ supports. Additionally, Cu is supported on these supports to manufacture catalysts. In particular, 0.45 g of the resulting catalyst and 0.1328 g of Cu(NO₃)₂·xH₂O (Copper nitrate hydrate) are added to a three-neck flask (S21). After adding 250 mL of ethanol and 0.59 mL of ammonia to the three-neck flask, the resulting mixture is heated, aged, filtered, dried and then sintered to manufacture the final catalysts.

Further, the water-gas shift reaction according to an embodiment of the present disclosure may be carried out as a high- and low-temperature continuous reaction process.

First, steam is injected through a high-temperature water-gas shift reactor 51 under high temperatures (250˜300° C.) to convert CO into CO₂ and H₂, with a yield is 60˜80%. Then, WGS is carried out continuously through a low-temperature water-gas shift reactor 52 at low temperatures (200˜250° C.).

Further, the configuration and method of the embodiments as described above are not restrictively applied to the aforementioned apparatus and method. The whole or part of the respective embodiments may be selectively combined so as to make various modifications of the embodiments.

### FIGURE REFERENCE NUMBERS

1: system for producing hydrogen using autothermal reforming
2: hydrocarbon storage tank
3: pre-treating portion
10: hydrocatalytic reactor
11: tail gas recycling tank
20: first heat exchanger
30: desulfurization/dechlorization adsorber
40: second heat exchanger
50: water-gas shift reactor
51: high-temperature water-gas shift reactor
52: low-temperature water-gas shift reactor
60: (PSA) hydrogen gas separator
61: hydrogen storage tank
62: tail gas storage tank
100: autothermal reforming reactor (ATR)
110: partial oxidation portion
111: housing
112: burner
113: supply line
114: pure oxygen supply portion
120: steam reforming portion
121: main body
122: steam supply device
123: stem pump

1. As a system for producing hydrogen from hydrocarbons, a system for producing hydrogen using autothermal reforming comprising:
a partial oxidation portion where hydrocarbons are fed in and undergoes partial oxidation;
a stem reforming portion that is connected to the partial oxidation portion, supplied with heat energy generated from the partial oxidation portion, and steam-reformed by a steam reforming catalyst to produce synthetic gas containing hydrogen; and
an integrated autothermal reforming reactor wherein the partial oxidation portion and the steam reforming portion are configured within a single integrated main body.

2. The system for producing hydrogen using autothermal reforming of claim 1, wherein
the partial oxidation portion is operated within a range of 1000˜1500° C. through a burner, and supplied with pure-oxygen as an oxidizer, and
a supply line through which hydrocarbons are supplied is spirally installed inside or outside a housing of the partial oxidation portion, and gasifies hydrocarbons through heat energy generated from the partial oxidation portion to supply inside the partial oxidation portion.

3. The system for producing hydrogen using autothermal reforming of claim 2 further comprising:
a PSA hydrogen separator that separates hydrogen from the synthetic gas; and
a hydrocatalytic reactor that is provided at the front end of the autothermal reforming reactor, and subjects the hydrocarbons to defulrization, dechlorization and denaphthaization, wherein
tail gas of the PSA is supplied to the hydrocatalytic reactor.

4. The system for producing hydrogen using autothermal reforming of claim 3 further comprising:
a desulfurization/dechlorization adsorber that is provided at the rear end of the autothermal reforming reactor, and adsorbs sulfur and chlorine inside the synthetic gas; and
a water-gas shift reactor that is provided between the PSA and the autothermal reforming reactor, and converts CO in the synthetic gas into carbon dioxide and hydrogen.

5. The system for producing hydrogen using autothermal reforming of claim 4, wherein
in the hydrocatalytic reactor,
H₂S, HCl, HNH₃ are produced through hydrogenation, unsaturated hydrocarbons are converted into saturated hydrocarbons, and denaphthaization is also carried out.

6. The system for producing hydrogen using autothermal reforming of claim 5, wherein
the water-gas shift reactor includes:
a high-temperature water-gas shift reactor that converts 60˜80% of CO into CO₂ and H₂ by injecting steam at a temperature range of 250˜300° C.; and
a low-temperature water-gas shift reactor that is connected to the rear end of the high-temperature water-gas shift reactor, and converts residual CO into CO₂ and H₂ by injecting steam at a temperature range of 200˜250° C.

7. The system for producing hydrogen using autothermal reforming of claim 5 further comprising:
a hydrogen storage tank for storing the hydrogen separated from the PSA; and
a tail gas storage tank for storing the tail gas of the PSA, wherein
the tail gas stored in the tail gas storage tank is supplied to the hydrocatalytic reactor and a gas burner of the partial oxidation reactor.

8. The system for producing hydrogen using autothermal reforming of claim 8, wherein
the gas containing the hydrocarbons, CO and hydrogen discharged from the hydrocatalytic reactor is supplied to the gas burner.

9. The system for producing hydrogen using autothermal reforming of claim 5 further comprising:
a pre-treating portion that is provided at the front end of the hydrocatalytic reactor, and undergoes pre-treatment through a porous support containing silica gel, clay, alkali metal oxide or alkaline earth metal oxide, iron oxide, ion exchange resin, activated carbon, activated aluminum oxide, molecular sieve, alkaline oxide, modified or unmodified layered double hydroxide, and silica gel.
